(19) United States
(12) Patent Application Publication
(10) Pub. No.: US 2004/0083643 A1
(43) Pub. Date: May 6, 2004

(54) Flying safety net device

(76) Inventor: Chien-Ching Wu, Taichung (TW)

Correspondence Address: Chien-Ching Wu, MA YUAN WEST ST., TAICHUNG, 58, TW

(21) Appl. No.: 10/350,381

(22) Filed: Jan. 21, 2003

(30) Foreign Application Priority Data
Nov. 6, 2002 (TW) 091208857

(51) Int. Cl. A01M 5/02; A01M 3/00

(52) U.S. Cl. 43/134

(57) ABSTRACT

A flying safety net device has a first post, a second post, a main net, a first main rope, a center rope, a second main rope, a first lateral rope, a second lateral rope, a first main loop, a second main loop, a third main loop, a fourth main loop, a first auxiliary loop, and a second auxiliary loop. The main net has a plurality of upper fringe thread sections, a plurality of lower fringe thread sections, a large number of netting thread sections, a large number of netting loops, and a large number of meshes. The first main rope passes through the upper fringe thread sections of the main net. The second main rope passes through the lower fringe thread sections of the main net. The center rope passes through a middle portion of the main net.

### BACKGROUND OF THE INVENTION

The present invention relates to a flying safety net device. More particularly, the present invention relates to a flying safety net device which is reinforced.

Referring to FIG. 1, a conventional flying safety net device has a post 17, a main loop 16 connected to the post 17, a main rope 12 connected to the main loop 16, a large number of netting thread sections 131, a large number of netting loops 14, a large number of enlarged meshes 13, a large number of small meshes 13a, and a plurality of residual threads 11. Since the main rope 12 passes through the netting thread sections 131 which are connected to the residual threads 11, a tension variation distance 1D will be equal to twice of a length of a netting thread section 131. When a strong wind blows the conventional flying safety net device, the enlarged meshes 13 will be enlarged and the small meshes 13a will be squeezed. Thus the netting thread sections 131 surrounding the enlarged meshes 13 will have a large tensile stress, so some of the netting thread sections 131 will be broken while a flying bird bumps the netting thread sections 131 surrounding the enlarged meshes 13.

### SUMMARY OF THE INVENTION

An object of the present invention is to provide a flying safety net device which has a large number of meshes to be enlarged or squeezed evenly while a strong wind blows the flying safety net device and a large number of netting thread sections not to be broken while a flying bird bumps the netting thread sections.

Accordingly, a flying safety net device comprises a first post, a second post, a main net, a first main rope, a center rope, a second main rope, a first lateral rope, a second lateral rope, a first main loop, a second main loop, a third main loop, a fourth main loop, a first auxiliary loop, and a second auxiliary loop. The first main loop is connected to the first post, the first main rope, and the first lateral rope. The second main loop is connected to the second post, the first main rope, and the second lateral rope. The third main loop is connected to the first post, the second main rope, and the first lateral rope. The fourth main loop is connected to the second post, the second main rope, and the second lateral rope. The first auxiliary loop is connected to the first post, the center rope, and the first lateral rope. The second auxiliary loop is connected to the second post, the center rope, and the second lateral rope. The main net has a plurality of upper fringe thread sections, a plurality of lower fringe thread sections, a large number of netting thread sections, a large number of netting loops, and a large number of meshes. The first main rope passes through the upper fringe thread sections of the main net. The second main rope passes through the lower fringe thread sections of the main net. The center rope passes through a middle portion of the main net.

### BRIEF DESCRIPTION OF THE DRAWINGS

FIG. 1 is an elevational view of a conventional flying safety net device of the prior art;

FIG. 2 is an elevational view of a flying safety net device of a preferred embodiment in accordance with the present invention;

FIG. 3 is a partially enlarged view of a flying safety net device of a preferred embodiment while a tension variation distance is increased;

FIG. 3A is a partially enlarged view of a flying safety net device of a preferred embodiment while a tension variation distance is shortened; and

FIG. 4 is a schematic view illustrating an application of a center rope of a preferred embodiment in accordance with the present invention.

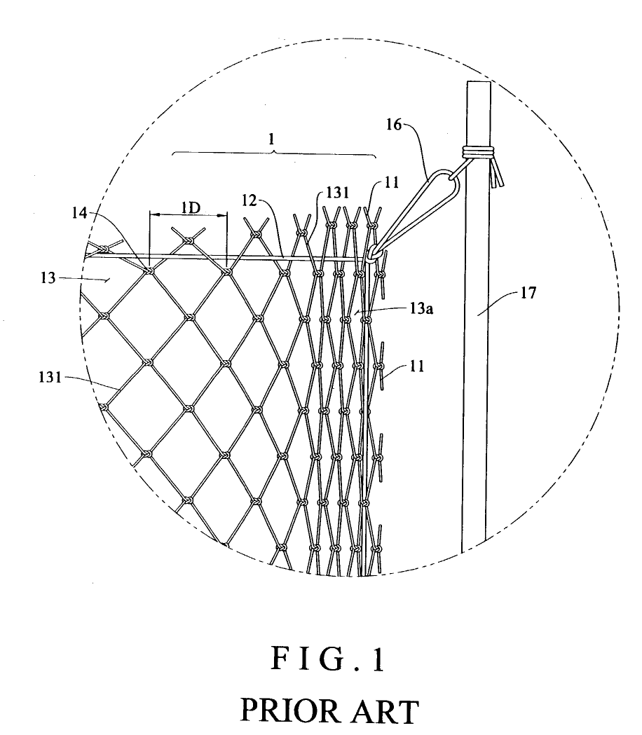

### DETAILED DESCRIPTION OF THE INVENTION

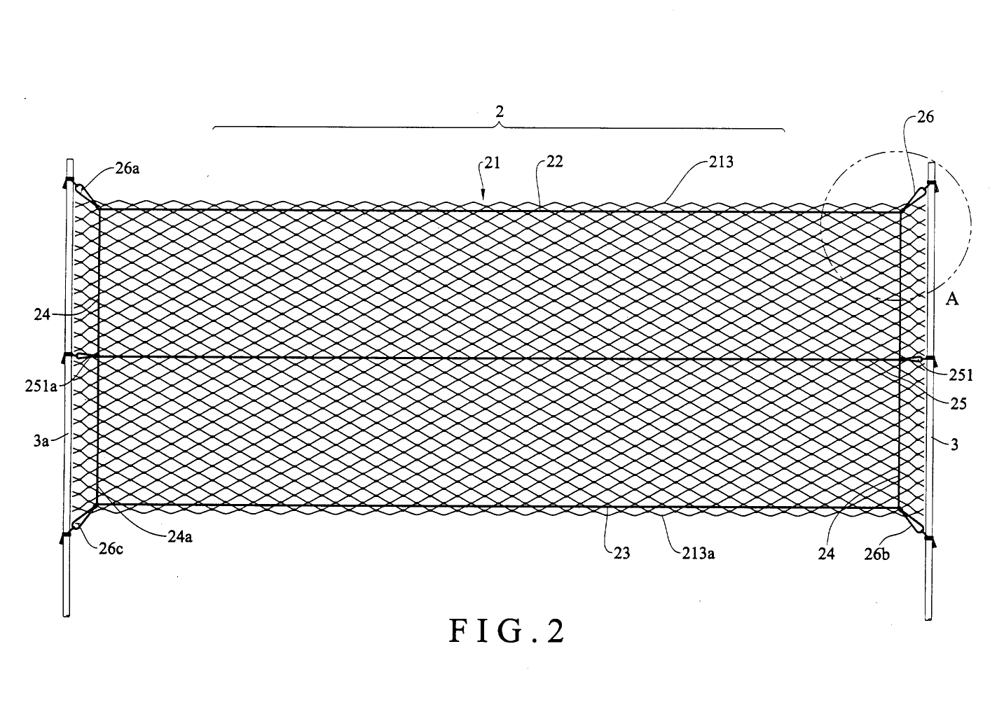

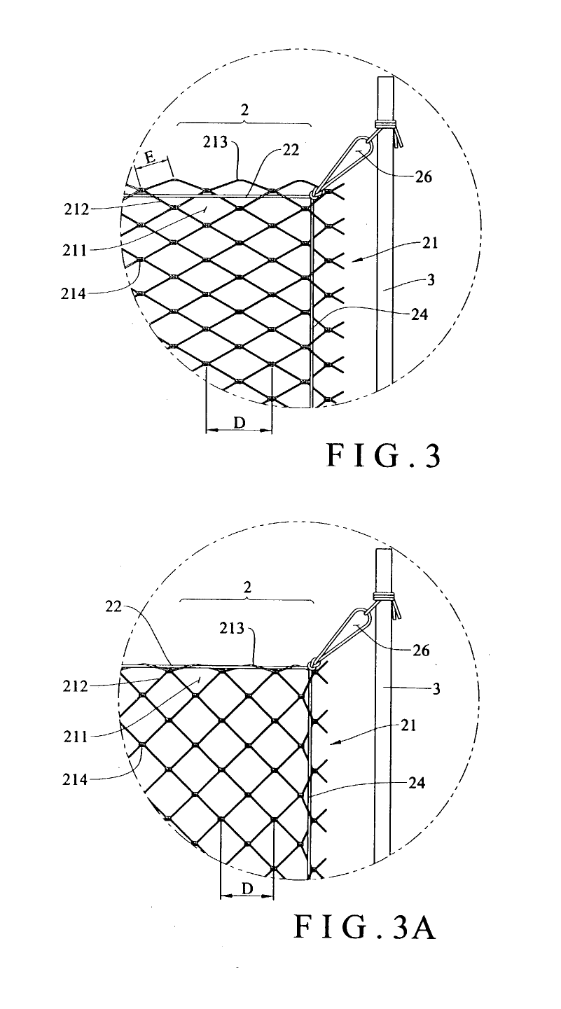

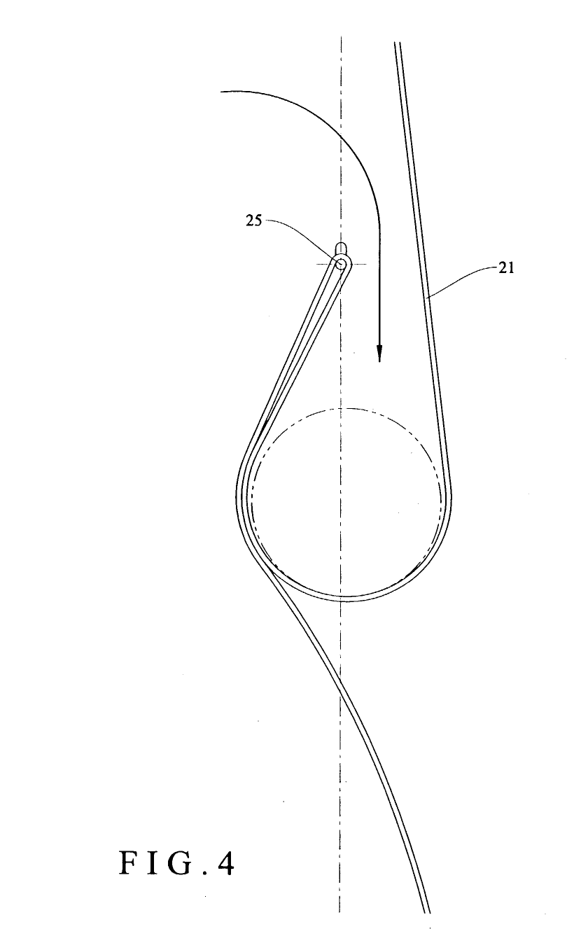

Referring to FIGS. 2 to 4, a flying safety net device 2 comprises a first post 3, a second post 3a, a main net 21, a first main rope 22, a center rope 25, a second main rope 23, a first lateral rope 24, a second lateral rope 24a, a first main loop 26, a second main loop 26a, a third main loop 26b, a fourth main loop 26c, a first auxiliary loop 251, and a second auxiliary loop 251a.

The first main loop 26 is connected to the first post 3, the first main rope 22, and the first lateral rope 24.

The second main loop 26a is connected to the second post 3a, the first main rope 22, and the second lateral rope 24a.

The third main loop 26b is connected to the first post 3, the second main rope 23, and the first lateral rope 24.

The fourth main loop 26c is connected to the second post 3a, the second main rope 23, and the second lateral rope 24a.

The first auxiliary loop 251 is connected to the first post 3, the center rope 25, and the first lateral rope 24.

The second auxiliary loop 251a is connected to the second post 3a, the center rope 25, and the second lateral rope 24a.

The main net 21 has a plurality of upper fringe thread sections 213, a plurality of lower fringe thread sections 213a, a large number of netting thread sections 212, a large number of netting loops 214, and a large number of meshes 211.

The first main rope 22 passes through the upper fringe thread sections 213 of the main net 21.

The second main rope 23 passes through the lower fringe thread sections 213a of the main net 21.

The center rope 25 passes through a middle portion of the main net 21.

A half length E of each upper fringe thread section 213 is shorter than a length of each netting thread section 212.

A half length of each lower fringe thread section 213a is shorter than a length of each netting thread section 212.

A tension variation distance D is less than twice of the length of each netting thread section 212.

Since the tension variation distance D of the present invention is shorter than the tension variation distance of the conventional flying safety net device of the prior art, the meshes 211 of the present invention will be enlarged or squeezed evenly while a strong wind blows the flying safety net device of the present invention.

The netting thread sections 212 of the present invention will not be broken while a flying bird bumps the netting thread sections so that the flying safety net device of the present invention is reinforced.

The present invention is not limited to the above embodiment but various modification thereof may be made. Furthermore, various changes in form and detail may be made without departing from the scope of the present invention.

I claim:

1. A flying safety net device comprises:
a first post, a second post, a main net, a first main rope, a center rope, a second main rope, a first lateral rope, a second lateral rope, a first main loop, a second main loop, a third main loop, a fourth main loop, a first auxiliary loop, and a second auxiliary loop,
the first main loop connected to the first post, the first main rope, and the first lateral rope,
the second main loop connected to the second post, the first main rope, and the second lateral rope,
the third main loop connected to the first post, the second main rope, and the first lateral rope,
the fourth main loop connected to the second post, the second main rope, and the second lateral rope,
the first auxiliary loop connected to the first post, the center rope, and the first lateral rope,
the second auxiliary loop connected to the second post, the center rope, and the second lateral rope,
the main net having a plurality of upper fringe thread sections, a plurality of lower fringe thread sections, a large number of netting thread sections, a large number of netting loops, and a large number of meshes,
the first main rope passing through the upper fringe thread sections of the main net,
the second main rope passing through the lower fringe thread sections of the main net, and
the center rope passing through a middle portion of the main net.

2. The flying safety net device as claimed in claim 1, wherein a half length of each said upper fringe thread section is shorter than a length of each said netting thread section.

3. The flying safety net device as claimed in claim 1, wherein a half length of each said lower fringe thread section is shorter than a length of each said netting thread section.
